(19) United States
(12) Patent Application Publication
(10) Pub. No.: US 2026/0132848 A1
(43) Pub. Date: May 14, 2026

(54) VEHICLE WITH A DUAL CLUTCH TRANSMISSION

(71) Applicant: AUDI AG, Ingolstadt (DE)

(72) Inventors: Lutz GUNDLACH, Ingolstadt (DE); Pina Michaela WRITZEL, Kösching (DE)

(21) Appl. No.: 19/381,802

(22) Filed: Nov. 6, 2025

(30) Foreign Application Priority Data
Nov. 11, 2024 (DE) 10 2024 132 768.5

(51) Int. Cl. F16H 61/688; F16H 61/04

(52) U.S. Cl. CPC F16H 61/688; F16H 61/04; F16H 2061/0462

(57) ABSTRACT

A vehicle is disclosed, and may include a dual clutch transmission, a first sub-transmission and a second sub-transmission of which may be activated by actuating respective first and second separating clutches. A time period for preparing the subsequent gear shift may comprise a separating clutch opening process and a gear engagement process. In order to reduce the preparation time period, the evaluation module may actuate a shift control unit such that the gear engagement process starts before completion of the separating clutch opening process, such that the separating clutch opening process and the gear engagement process temporally overlap in an overlap time interval.

### BACKGROUND

### Technical Field

The present disclosure relates to a vehicle with a dual clutch transmission.

### Description of the Related Art

In a generic dual clutch transmission, a first sub-transmission and a second sub-transmission may be activated by actuating respectively assigned first and second separating clutches. Each of the sub-transmissions has at least one synchronizing clutch with which a gear may be engaged. During driving operation, a subsequent gear shift is carried out in an automated manner by way of an electronic shift control unit in order to shift into a target gear. For this purpose, the shift control unit engages the target gear in a gear engagement process in the passive, i.e., inactive, sub-transmission in preparation for the subsequent gear shift. Prior to the gear engagement process, an evaluation module checks whether the separating clutch of the passive sub-transmission is closed. Such a closed separating clutch in the passive sub-transmission arises in a special situation, for example during a process for determining the kiss point, which defines the position of a separating clutch actuator at which the clutch release clearance is used up and torque is transmitted via the separating clutch.

When a closed separating clutch of the passive sub-transmission is present, the evaluation module actuates a clutch control unit in order to fully open the separating clutch in a separating clutch opening process, thereby ensuring a torque-free engagement of the target gear. The time period for preparing the subsequent gear shift is therefore comprised of the separating clutch opening process and the gear engagement process. In the prior art, the gear engagement process is only started after the separating clutch opening process has been completed. Therefore, in the prior art, the time period until the subsequent gear shift is finally started is correspondingly long.

DE102006060285A1 discloses a method for minimizing interruption of tractive force during upshifts in an automated manual transmission. Upon receipt of an upshift signal, a control device causes the friction clutch to open as quickly as possible, subsequently or in a temporarily overlapping manner, disengage an engaged original gear as quickly as possible, and engage a target gear. After engagement of the target gear, the friction clutch is adjusted, on the one hand, to transmit torque between the drive motor and the input shaft of the automated manual transmission within a slip range, and, on the other hand, to actively influence the torque output of the drive motor.

DE102016202286A1 discloses a method for operating a dual clutch transmission of a motor vehicle, wherein a first clutch is operated in a closed state and thereby drives a first transmission branch in which a current actual gear is engaged, and in a pre-selection phase for a gear change to a target gear in a second transmission branch the target gear is engaged and in a second clutch a clutch hydraulic system is filled and thereby the second clutch is closed.

### BRIEF SUMMARY

The present disclosure provides a vehicle with a dual clutch transmission in which the overall shift time is reduced compared to the prior art.

The present disclosure relates to a dual clutch transmission, a first sub-transmission and a second sub-transmission of which may be activated by actuating respectively assigned first and second separating clutches. Each of the sub-transmissions has at least one synchronizing clutch with which a gear can be engaged. During driving operation, a subsequent gear shift is carried out in an automated manner by way of an electronic shift control unit in order to shift into a target gear. For this purpose, the shift control unit may engage the target gear in a gear engagement process in the passive, i.e., inactive, sub-transmission in preparation for the subsequent gear shift. Prior to the gear engagement process, an evaluation module may check whether the separating clutch of the passive sub-transmission is closed. Such a closed separating clutch in the passive sub-transmission may arise in a special situation, for example during a process for determining the kiss point, which defines the position of a separating clutch actuator at which the clutch release clearance is used up and torque is transmitted via the separating clutch.

When a closed separating clutch of the passive sub-transmission is present, the evaluation module may actuate a clutch control unit in order to fully open the separating clutch in a separating clutch opening process, thereby ensuring a torque-free engagement of the target gear. The time period for preparing the subsequent gear shift may therefore be comprised of the separating clutch opening process and the gear engagement process.

The evaluation module may actuate the shift control unit to start the gear engagement process before completion of the separating clutch opening process to reduce the preparation time period. According to the present disclosure, the separating clutch opening process and the gear engagement process may therefore overlap in an overlap time interval, which results in a reduced overall shift time compared to the prior art.

The present disclosure may utilize that the separating clutch opening process may be divided into a torque-transmitting opening phase until a kiss point is reached, and a torque-free opening phase after the kiss point has been reached, during which a torque-free clutch release clearance builds up in the separating clutch. According to the present disclosure, the evaluation module actuates the shift control unit such that the gear engagement process may begin early, at least in the torque-free opening phase of the separating clutch opening process.

The present disclosure may alternatively and/or additionally utilize that the gear engagement process may also be divided into a torque-free engagement phase and a torque-transmitting engagement phase, during which a synchronizing friction torque builds up in the gear shift package. Against this background, the evaluation module may actuate the shift control unit such that the gear engagement process starts before the kiss point in the separating clutch of the passive sub-transmission is reached. The kiss point of the separating clutch of the second sub-transmission may therefore be established at a time when the torque-free engagement phase of the gear engagement process is already underway. After the kiss point is reached, the torque-transmitting engagement phase of the gear engagement process may begin.

The evaluation module may be in signal communication with a clutch sensor system, which detects a contact pressure acting in the separating clutch of the passive sub-transmission or a parameter correlating therewith. The evaluation module may determine the kiss point of the separating clutch on the basis of, among other things, the detected contact pressure and a corresponding torque transmission. The kiss point may define the position of an actuator of the separating clutch, starting from which a torque transmission via the separating clutch takes place as the contact pressure increases, and starting from which a torque-free clutch release clearance is established as the contact pressure decreases.

After the target gear has been engaged, i.e., after the preparation time period has elapsed, the subsequent gear shift may be carried out during which, the evaluation module actuates the clutch control unit to close the separating clutch of the still passive sub-transmission. At the same time, the clutch control unit may open the separating clutch of the active sub-transmission, thus completing the subsequent gear shift.

In some embodiments, a vehicle drive unit, such as an internal combustion engine, may operationally be connected to a power output shaft alternately either to a first drive shaft or to a second drive shaft via the two load-switchable separating clutches of the dual-clutch transmission. The first sub-transmission or the second sub-transmission may be activated in each case by way of the two drive shafts. Fixed and idler gears may be arranged on the two drive shafts and on an output shaft, which may be axially parallel thereto, and which are combined to form gear sets, forming gear stages. In these gear sets, the idler gears may be coupled to the respective transmission shaft by way of the gear shift elements.

The gear shift elements installed in the dual clutch transmission may be implemented as synchronous clutches that are axially adjustable on one or both sides. Such a synchronous clutch may have a sliding sleeve that is axially adjustable over a shifting path by way of a shift fork. The shift fork may be adjusted over the actuation path, for example, by a hydraulically operated actuator. An internal gearing of the sliding sleeve may be mounted in an axially adjustable manner on a corresponding external gearing of a sliding sleeve carrier that is mounted on a transmission shaft in a rotationally fixed manner. The sliding sleeve may be moved into a shift position by way of the shift fork, in which the internal gearing of the sliding sleeve meshes with both the external gearing of the sliding sleeve carrier and the external gearing of an idler gear clutch body.

### BRIEF DESCRIPTION OF THE SEVERAL VIEWS OF THE DRAWINGS

FIG. 1 shows a schematic view of a transmission structure of a drive train of a vehicle with a dual clutch transmission installed therein according to the present disclosure.

FIG. 2 shows a diagram illustrating a chronological sequence during the preparation of a subsequent gear shift according to the prior art.

FIG. 3 shows a diagram corresponding to FIG. 2, illustrating the chronological sequence of a preparation of the sequential circuit according to the present disclosure.

### DETAILED DESCRIPTION

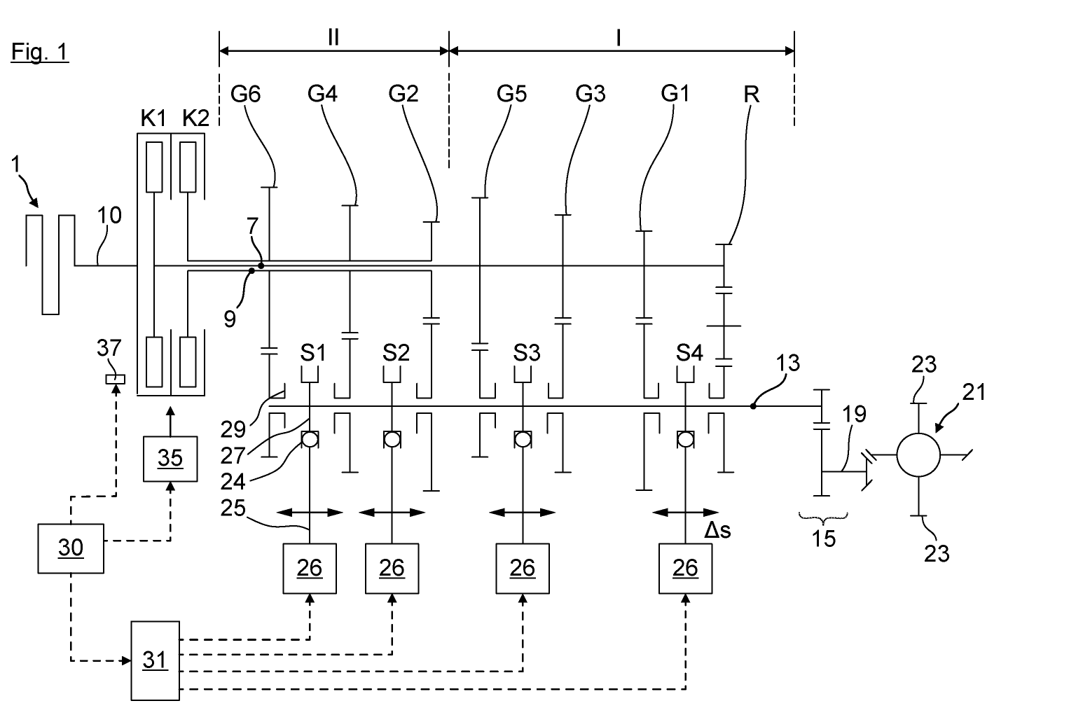

FIG. 1 shows a transmission structure of a motor vehicle drivetrain comprising an internal combustion engine 1 and a dual clutch transmission. The dual clutch transmission may have a first drive shaft 7 and a second drive shaft 9. The first and second drive shafts 7, 9 may be arranged coaxially and may be alternately connected to a power output shaft 10 of internal combustion engine 1 in a torque-transmitting manner via two, for example, hydraulically actuated, load-switchable separating clutches K1, K2. First drive shaft 7 is implemented in FIG. 1 as a solid shaft, which is guided coaxially within second drive shaft 9, which is implemented as a hollow shaft. An output shaft 13 may be provided axially parallel to two drive shafts 7, 9. The output shaft 13 may drive onto an input shaft 19 of an axle differential 21 via a gear stage 15 with spur gears. From the axle differential 21, flange shafts 23 may extend on both sides to vehicle wheels (not shown).

A first sub-transmission I and a second sub-transmission II of the dual clutch transmission may be activated by way of first and second drive shafts 7, 9, respectively. When viewed in the axial direction, first sub-transmission I may be arranged remote from the clutch, while second sub-transmission II may be arranged close to the clutch. Fixed and idler gears may be arranged in gear planes on two drive shafts 7, 9 and on output shaft 13. The fixed and idler gears may be combined to form gear sets, forming six forward gear stages G1, G2, G3, G4, G5, G6 and one reverse gear stage R. In the figure, the idler gears for all gear stages are positioned on the output side of output shaft 13. The idler gears may be engaged using gear shift elements S1, S2, S3, S4, which are also positioned on output shaft 13.

Each of gear shift elements S1, S2, S3, S4 may be implemented as a synchronous clutch with a sliding sleeve 24, which is axially adjustable on both sides over an actuation path Δs by way of shift fork 25, as indicated. Sliding sleeve 24 may be positioned with internal toothing thereof (not shown) on a corresponding external toothing of a sliding sleeve carrier 27 arranged in a rotationally fixed manner on output shaft 13. Each of sliding sleeves 24 is positioned in a neutral position in FIG. 1. Starting from the neutral position, sliding sleeves 24 may be moved into a shift position in order to engage one of gears G1, G2, G3, G4, G5, G6 or R. In the shift position, the sliding sleeve internal toothing may mesh, on the one hand, with sliding sleeve carrier 27 and, on the other hand, with the external toothing of a clutch body 29 of idler gear.

Each of shift forks 25 in FIG. 1 may be operatively connected to a hydraulically operating actuator 26, which may be actuated by a shift control unit 31. When appropriately actuated, shift fork 25 may be axially adjusted over an actuation path Δs to bring associated shift sleeve 24 into or out of clutch engagement with an idler gear.

In FIG. 1, shift control unit 31 and a clutch control unit 35 may be actuated by an evaluation module 30. Evaluation module 30 may be in signal communication with a sensor system, which detects a contact pressure acting in separating clutches K1, K2 or a parameter correlating therewith. Evaluation module 30 may determine kiss point KP of separating clutch K1, K2 based on the detected contact pressure and a corresponding transmittable clutch torque.

A shifting strategy may be stored in evaluation module 30 in order to carry out a subsequent gear shift into a target gear without interruption of tractive force, in which a shift is made from a current gear of one sub-transmission (or alternatively from a neutral position) into the target gear of the other sub-transmission.

The present disclosure may reduce the overall shift time during the automatic subsequent gear shift. This may be achieved by engaging the target gear earlier than in the prior art.

A comparative example of the prior art is explained with reference to FIG. 2. The diagram of FIG. 2 illustrates the time course of the preparation of a subsequent gear shift (i.e., a gear shift to the target gear) carried out during driving operation, in which, for example, the current gear is third gear G3 in sub-transmission I and the target gear is fourth gear G4 in sub-transmission II.

Accordingly, evaluation module 30 first actuates clutch control unit 35 to move gear shift element S1 (marked with a dashed line in the diagram) from its neutral position to its shift position during a gear engagement process t_{Z},thereby engaging target gear G4 in the still passive second sub-transmission II. Evaluation module 30 then actuates clutch control unit 35 and shift control unit 31 to disengage current sub-transmission I and current gear G3.

Prior to the start of gear engagement process t_{Z}, evaluation module 30 checks, however, whether separating clutch K2 of the still passive sub-transmission II is closed. This is the case at time t = 0 in the diagram of FIG. 2. If such a closed separating clutch K2 of passive sub-transmission II is present, evaluation module 30 actuates clutch control unit 35 in order to fully open separating clutch K2 (marked with a solid line in the diagram) in a separating clutch opening process t_{K}, thereby ensuring torque-free engagement of target gear G4. The time period t_{V} indicated in the diagram of FIG. 2 for preparing the subsequent gear shift therefore results from the separating clutch opening process t_{K} and from the gear engagement process t_{Z}. In the diagram of FIG. 2, the gear engagement process t_{Z} only starts when separating clutch K2 is fully open, i.e., when the separating clutch opening process t_{K} is fully completed. Therefore, in FIG. 2, the preparation for the subsequent gear shift (i.e., shifting into fourth gear G4) takes a correspondingly long preparation time t_{V}.

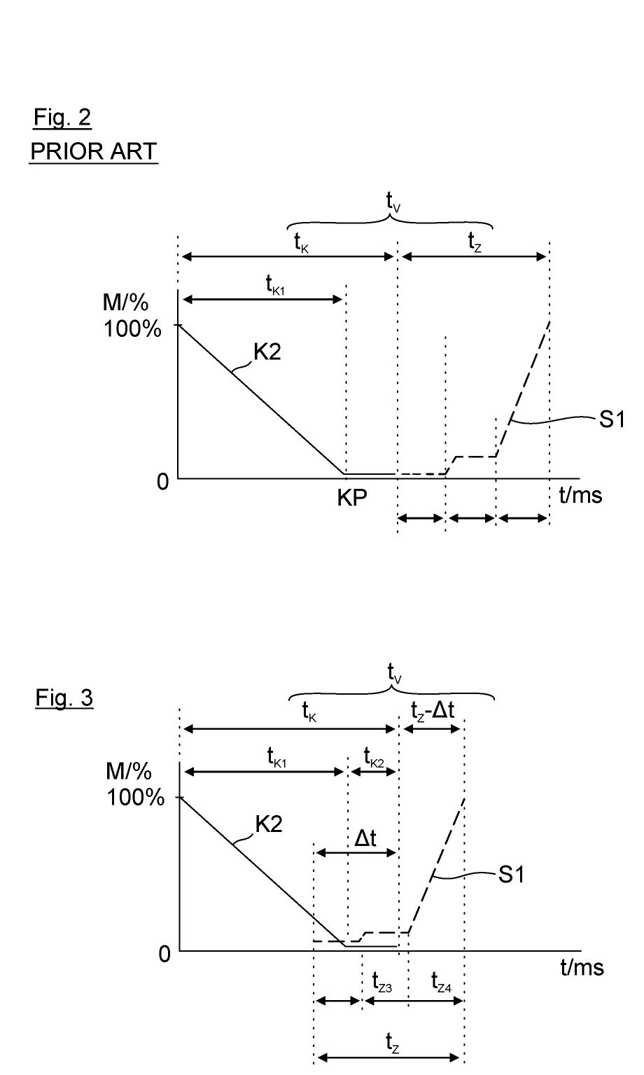

In contrast to FIG. 2, the diagram of FIG. 3 indicates the time course for the preparation of a sequential circuit according to the present disclosure. In the sequential circuit according to the present disclosure, the separating clutch opening process t_{K} may be divided into an initial torque-transmitting opening phase t_{K1}, which lasts until a kiss point KP is reached, and a subsequent torque-free opening phase t_{K2}, which starts at kiss point KP. In torque-free opening phase t_{K2}, a torque-free clutch release clearance may be built up in separating clutch K2. Kiss point KP defines a position of a separating clutch actuator, starting from which a torque transmission via separating clutch K2 takes place when the contact pressure increases, and starting from which the torque-free clutch release clearance is established when the contact pressure falls.

Gear engagement process t_{Z} may be divided into the following four phases: a torque-free first engagement phase t_{Z1}, in which gear shift element S1 uses up a mechanical movement play, namely without any actuating movement of gear shift element S1 taking place; a torque-free second engagement phase t_{Z2}, in which gear shift element S1 moves from the neutral position until gear shift element S1 contacts the still locking synchronizer ring (i.e., the synchronization point is reached); a torque-transmitting third engagement phase t_{Z3}, in which gear shift element S1 remains until the input shaft is synchronized to the synchronization speed due to the acting friction torque of the synchronizer package; and a torque-transmitting fourth engagement phase t_{Z4}, in which the synchronizer ring rotates until the locking effect is canceled and the gear selector can move the sliding sleeve further into the toothing, namely, until the sliding sleeve reaches an engagement position, whereby target gear G4 is engaged.

In order to prepare for the subsequent gear shift (i.e., shifting into target gear G4), evaluation module 30 may actuate shift control unit 31 such that the torque-free engagement phase t_{Z1} already starts before kiss point KP of separating clutch K2 of the second sub-transmission. As separating clutch K2 reaches kiss point KP during separating clutch opening process t_{K}, at least torque-free engagement phase t_{Z1} or torque-free second engagement phase t_{Z2} of gear shift element S1 may already be underway. After kiss point KP has been reached (and before separating clutch process t_{K} has ended), torque-transmitting third engagement phase t_{Z3} may begin, followed by torque-transmitting fourth engagement phase t_{Z4} of gear engagement process t_{Z}, in which gear shift element S1 is moved into a shift position. Due to the gear engagement process t_{Z} being brought forward in time (compared to FIG. 2), separating clutch opening process t_{K} and gear engagement process t_{Z} may overlap in an overlap time interval Δt. The preparation time period t_{V} for preparing the target gear subsequent gear shift may thus be significantly reduced compared to the prior art (i.e., FIG. 2).

After target gear G4 has been engaged, that is to say after the preparation time period t_{V} has elapsed, the subsequent gear shift may be carried out, in which evaluation module 30 actuates clutch control unit 31 in order to close separating clutch K2 of still passive sub-transmission II, specifically with an overlapping opening of separating clutch K1 of still active sub-transmission I, whereby the subsequent gear shift is completed.

German patent application no. 102024132768.5, filed November 11, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A vehicle comprising:
a dual clutch transmission including:
a first sub-transmission configured to be activated by actuation of a first separating clutch; and
a second sub-transmission configured to be activated by actuation of a second separating clutch;
a shift control unit;
an evaluation module configured to detect, in advance of a gear engagement process, whether the second separating clutch is closed; and
a clutch control unit,
wherein each of the first and second sub-transmissions has at least one gear shift element configured to engage a gear,
wherein the shift control unit is configured to conduct a gear shift in which a target gear is engaged by the gear shift element during driving operation,
wherein the shift control unit is configured to engage the target gear in the second sub-transmission in preparation for the gear shift in a gear engagement process,
wherein when the evaluation module detects that the second separating clutch of the second sub-transmission is closed before the gear engagement process, the evaluation module is configured to actuate the clutch control unit to fully open the second separating clutch in a separating clutch opening process, such that a torque-free engagement of the target gear by a respective gear shift element occurs,
wherein the preparation of the gear shift includes the separating clutch opening process and the gear engagement process, and
wherein the evaluation module is configured to actuate the shift control unit such that the gear engagement process begins before completion of the separating clutch opening process, such that the separating clutch opening process and the gear engagement process temporally overlap in an overlap time interval.

2. The vehicle according to claim 1, wherein the separating clutch opening process includes an initial torque-transmitting opening phase that proceeds until a kiss point is reached and a subsequent torque-free opening phase after the kiss point has been reached, and
wherein in the torque-free opening phase, a torque-free clutch release clearance increases in the second separating clutch.

3. The vehicle according to claim 2, wherein in the torque-free opening phase, the evaluation module is configured to actuate the shift control unit such that the gear engagement process begins during the torque-free opening phase of the separating clutch opening process.

4. The vehicle according to claim 1, wherein the gear engagement process includes at least one torque-free engagement phase and at least one torque-transmitting engagement phase, and
wherein in the at least one torque-transmitting engagement phase, a synchronizing friction torque increases.

5. The vehicle according to claim 4, wherein in the at least one torque-transmitting engagement phase, the evaluation module is configured to actuate the shift control unit such that the torque-free engagement phase begins before a kiss point of the separating clutch of the second sub-transmission is reached, and such that the kiss point of the second separating clutch of the second sub-transmission is established during the torque-free engagement phase of the gear engagement process, and
wherein after the kiss point is reached, the torque-transmitting engagement phase of the gear engagement process begins.

6. The vehicle according to claim 1, further comprising a sensor system configured to detect a contact pressure acting in the second separating clutch of the second sub-transmission,
wherein the evaluation module is in signal communication with the sensor system, and
wherein the evaluation module is configured to determine a kiss point of the second separating clutch based on the detected contact pressure and a corresponding transmittable clutch torque.

7. The vehicle according to claim 1, wherein after the target gear has been engaged, the evaluation module is configured to actuate the clutch control unit to close the second separating clutch of the second sub-transmission.

8. The vehicle according to claim 7, wherein after the target gear has been engaged, the evaluation module is configured to actuate the clutch control unit to close the second separating clutch of the second sub-transmission and to simultaneously open the first separating clutch of the first sub-transmission.

9. The vehicle according to claim 1, wherein the second separating clutch of the second sub-transmission is closed during determination of a kiss point, the kiss point defining a position of an actuator of the second separating clutch, from which a torque transmission via the second separating clutch occurs as contact pressure increases, and from which a torque-free clutch release clearance is established as the contact pressure decreases.

10. The vehicle according to claim 1, further comprising wherein a vehicle drive unit with a power output shaft configured to alternatively drive a first drive shaft via the first separating clutch or a second drive shaft via the second separating clutch , such that the first sub-transmission or the second sub-transmission can be activated by way of the respective first and second drive shafts,
wherein fixed gears and idler gears are each arranged on each of the first and second drive shafts and on an output shaft,
wherein the fixed and idler gears collectively form gear sets to form forward gear stages, and
wherein the idler gears of the gear sets are configured to be coupled to a respective shaft of the first drive shaft, the second drive shaft, and the output shaft by way of a respective gear shift element.

11. The vehicle according to claim 10, wherein the first drive shaft, the second drive shaft, and the output shaft are axially parallel to one another.

12. The vehicle according to claim 10, wherein the vehicle drive unit is an internal combustion engine.

13. The vehicle according to claim 1, wherein the evaluation module includes a position measuring system for determining a kiss point.

14. The vehicle according to claim 1, wherein each of the at least one gear shift element is a synchronizing clutch.

15. A method for engaging a target gear in a dual clutch transmission of a vehicle, the method comprising:
engaging the target gear in the second sub-transmission by a shift control unit in a gear engagement process; and
detecting whether the second separating clutch of the second sub-transmission is closed before the gear engagement process by the evaluation module, and when the evaluation module detects the second separating clutch is closed, actuating the clutch control unit to fully open the second separating clutch in a separating clutch opening process, such that a torque-free engagement of the target gear by a respective gear shift element occurs,
wherein the shift control unit is actuated such that the gear engagement process begins before completion of the separating clutch opening process, such that the separating clutch opening process and the gear engagement process temporally overlap in an overlap time interval.
